(19) United States
(12) Patent Application Publication
(10) Pub. No.: US 2011/0166925 A1
(43) Pub. Date: Jul. 7, 2011

(54) METHOD AND SYSTEM FOR CONTENT SCHEDULING ON DISPLAY MEDIA

(75) Inventors: Rajendra Kumar Khare, Bangalore (IN); Ravi Bhat, Bangalore (IN); Abhijit Das, Bangalore (IN); Manjit Rath, Bangalore (IN); Saurabh Singh, Bangalore (IN); Anant Kansal, Bangalore (IN)

(73) Assignee: BeOnLine Technologies Private Limited, Bangalore (IN)

(21) Appl. No.: 12/741,209

(22) PCT Filed: Nov. 4, 2008
(86) PCT No.: PCT/IN08/00734

§ 371 Date: May 4, 2010

(30) Foreign Application Priority Data
Nov. 4, 2007 (IN) 2007/CHE/2007

(51) Int. Cl. G06F 3/048; G06Q 30/00; G06F 15/16

(52) U.S. Cl. 705/14.43; 709/203; 715/781

(57) ABSTRACT

Methods and systems of selection of content based on demographics and/or psychographics of a group from a remote central location through local commands on an input device from content that is sourced from the internet and/or a central database are provided. The system comprises Internet (101), central server (102), plurality of connecting means (103), plurality of smart IBs (104), plurality of screen IDs (105) and plurality of engagement means (106). The system initalizes display media screens with IDs (105), initalizes database with content stored in central server (102), receives information fed through the engagement means (106), updates the database according to the information and schedules data/content according to psychographic and/or demographic content stored in the database for a different region.

### CROSS REFERENCE TO RELATED APPLICATION

This application is related to Indian Provisional Patent Application No. 2507/CHE/2007 filed on Nov. 4, 2007. The entire contents of which are incorporated herein by this reference. The applicant hereby claims the benefit of this earlier pending provisional application

### FIELD OF THE INVENTION

The present invention relates to a method and system of selection of content based on anticipation of the demographics and/or psychographics of the group from a remote central location through local commands on an input device for content that is sourced from the World Wide Web (internet) and/or the central database.

The invention also relates to a method and system to combine the power of ‘pull’ from the internet with the power to ‘push’ through a TV screen placed at a location group viewing using a remote control through a set of commands transmitted over internet/secure network to the remotely located display media. Thus, the instant invention can be used for web based control for TV content scheduling.

The instant invention also facilitate to divide the display (viewable) region into plurality of different regions, wherein such regions are fed with information through different sources like internet, server, broadcast data and controlled through a centralized location.

The present invention also relates to a method and system having provisions to utilise the options available in a mobile communication device to transmit data such as text, image or video data to the intelligent box (IBs) attached with the display media (screen) using short range wireless technology such as Bluetooth.

The instant invention also relates to a method and system that utilizes the demographic and geographic data available with it to create various subsets like retail, corporate FMCG, sets based on people visiting the vicinity like their age group or buying pattern and capability to target potential buyers.

The present invention in yet another aspect relates to a method and system to facilitate intelligent content delivery by shared use of satellite bandwidth for delivery of customised video content saves on broadband bandwidth required for delivery of heavy duty video content for digital signage space and header protocol for delivery of client specific content on a group of display media (screens).

The instant invention in yet another aspect relates to a method and system to facilitate the use of stored content under remote control which can be used to deliver quality audio and/or video and avoid the effects of trees, bridges, tall buildings etc. for trains and buses thereby removing the poor transmission and reception problems.

### BACKGROUND OF THE INVENTION

Ever since its inception television has become an integral part of our daily life. It has become an important medium for entertainment, information, advertising and infotainment having streams of information for viewers. Moreover, in the present day scenario television has got too fragmented with several hundred of channels available at the choice of the viewer and the broadcaster has no control over viewership.

In the conventional TV system, for the most part, only one channel at a time can be viewed. This way the end-user/viewer is constrained to watch only one channel only at one point of time. Individuals choose a particular channel they want to watch and keep shifting pretty often to others as per their choice. Thus, from an advertiser's angle, it is difficult to reach out a message to promote their products and services to a target group without having to choose a number of different channels. These costs a lot of money as multiple channels are expensive with only a small percentage of the viewers being the right target viewers. This is like carpet bombing where a lot of ammunition is wasted for a small set of target viewers. Even when the channels are chosen right and the viewers watch the selected program, they have a general tendency to switch channels during a commercial break. As a result the end objective of viewers watching the brand message is not achieved.

Unlike internet where each click can be tracked and measured for generating analytics, in a TV, there is no way to know whether the message was viewed by a particular viewer/or home and whether the viewer was influenced to make a purchase decision after viewing the brands message. People meters have been used to measure the viewership by distributing them amongst a small sample of homes. However, people meters are believed to be not covering all types of socio-economic, psychographic, geographic profiles and the results are subject to proper use of people meters by the home users/viewers where they have been installed. So viewership data so generated is highly prone to errors and hence cannot be considered reliable.

Similarly, internet delivers a brand message to an individual viewer when he/she pulls the specific content on their machine. This does not help a brand to reach a group of viewers simultaneously unless each of them pulls the content. Moreover, internet as a medium is quite cluttered and not as visually appealing and readable as the TV, which is a more vivid medium. In IPTV, the content is streaming from a single server where a library of content has been stored but there is no active pulling of content from the internet in real-time based on dynamic behaviour of the location clients.

Moreover, the psychographic data, when used in conjunction with extensive database of demographic and product purchase/usage information, gives marketers a clearer picture than ever of what drives consumer behavior.

Demographic and psychographic enhancement data can dramatically improve a target marketing program because this information is critical to determining what to promote. Specifically, such data can be used to profile a database, create homogeneous “life-stage” segments, assist in building powerful predictive models, and increase the “rentability” of customers.

Demographics or demographic data refers to selected population characteristics as used in government, marketing or opinion research, or the demographic profiles used in such research.

In general, psychographic variables are any, attributes relating to personality, values, attitudes, interests, or lifestyles. They are also called IAO variables (for Interests, Attitudes, and Opinions). They can be contrasted with demographic variables (such as age and gender), and behavioral variables (such as usage rate or loyalty).

When a relatively complete assessment of a person or group's psychographic make-up is constructed, this is called a psychographic profile. Psychographic profiles are used in market segmentation and advertising.

Hence there is a need to evolve such methods and systems that anticipate the dynamic behaviour of the users/viewers taking into account the selection of content based on anticipation of the demographics and/or psychographics of the group at the client location where the intelligent appliances are located and pulling and pushing content based on this intelligence to display screens.

Further limitations and disadvantages of conventional and traditional approaches will become apparent to one skilled in the art, through comparison of such systems with some aspects of the present invention. The novel and inventive features believed characteristics of the invention are set forth in the appended claims. The invention itself, however, as well as preferred modes of use, further objects and advantages thereof, will be best understood by reference to the following detailed description of illustrative embodiments when read in conjunction with the accompanying drawings.

### SUMMARY OF THE INVENTION

One object of the present invention is to facilitate selection of content based on the anticipation of the demographic/psychographic of the group from a remote central location as against individual selection for content done by individuals through local commands on an input device for content that is sourced from the internet/or the central database.

Yet another objective of the instant invention is to combine the power of ‘pull’ from the internet with the power to ‘push’ through a TV screen placed at a location group viewing using a remote control through a set of commands transmitted over internet/secure network to the remotely located display media.

Yet another objective of the instant invention to divide the display (viewable) region into plurality of different regions, wherein such regions are fed with information through different sources like internet, server, broadcast data and controlled through a centralized location.

Yet another objective of the instant invention is to utilize the options available in a mobile communication device to transmit data such as text, image or video data to the intelligent box attached with the display screen using short range wireless technology such as Bluetooth.

Yet another objective of the instant invention is to pull and display information from the Internet and/or central server based on plurality of parameters. For example, based on weather forecast for a location.

Yet another objective of the instant invention is to utilize the demographic and geographic data available with it to create various subsets like retail, corporate FMCG, sets based on people visiting the vicinity like their age group or buying pattern and capability to target potential buyers.

Yet another objective of the instant invention is to facilitate intelligent content delivery by shared use of satellite bandwidth for delivery of customised video content saves on broadband bandwidth required for delivery of heavy duty video content for digital signage space and header protocol for delivery of client specific content on a group of display media (screens).

Yet another objective of the present invention is to facilitate the use of stored content under remote control which can be used to deliver quality audio and/or video and avoid the effects of trees, bridges, tall buildings etc. for trains and buses thereby removing the poor transmission and reception problems.

Thus the disclosed methods and system can be used for web based control for TV content scheduling, user generated content generation, voting and administrative purposes. The methods and systems of the instant invention, in their alternate embodiments' can further be used to facilitate controlled delivery of news, delivery parameters selectable by the method of being round robin, order control, number of messages per stop, percentage based control on news items for a cable TV. In alternate embodiments, the methods and systems of the instant invention may be used in News publish tools, content automation capability to gather location specific content and deliver on TV with editing capability, collaborative schedule control, content aggregation and delivery of TV like displays, customer specific logos, branded channels for customized communication strategy, and remote control of live TV/PVR capability for TV screens.

### BRIEF DESCRIPTION OF ACCOMPANYING DRAWINGS

Non-limiting and non-exhaustive features of the present invention together with its objects and advantages are described with reference to the accompanying drawings, like reference numerals refer to like elements throughout the various figures unless specified otherwise and wherein:

FIG. 1A illustrates a system for selection of content on anticipation of the demographic/psychographic of the group of remote central location through location commands on an input device wherein each display media has a respective connecting means according to a preferred embodiment of the present invention.

FIG. 1B illustrates a system for selection of content on anticipation of the demographic/psychographic of the group of remote central location through location commands on an input device wherein each display media is connected to a single connecting means according to a preferred embodiment of the present invention.

FIG. 2 depicts plurality of display regions wherein based on the screen id data different regions display different data according to a preferred embodiment of the present invention.

FIG. 3 illustrates a satellite and/or World Wide Web (Internet) transmission/reception system wherein the display media receives data from plurality of places viz. the internet (as push) and television broadcast (as pull) according to a preferred embodiment of the present invention.

FIG. 4 is a block diagram illustrating a video processing system which schedules the content on different display regions according to the database containing psychographic, demographic data on different display regions according to a preferred embodiment of the present invention.

FIG. 5 illustrates a flow diagram depicting a method for selection of content on different display regions according to the database containing psychographic, demographic data on different regions according to a preferred embodiment of the present invention.

FIG. 6 illustrates a flow diagram depicting a method of dividing the viewable region of a display media (screen) with IDs into plurality of different regions according to a preferred embodiment of the present invention.

FIG. 7 is a flow diagram depicting a method of determining number of regions of a display media (screen) with IDs with regional co-ordinates in plurality of display regions according to a preferred embodiment of the present invention.

FIG. 8 illustrates a system diagram of controlling the behaviour of the display device (screen) and its surroundings by one or more server through smart IBs or through engagement means according to a preferred embodiment of the present invention.

FIG. 9 illustrates a flow diagram depicting a method to utilize the options available in a mobile communication device to transmit data such as text, image or video data to the intelligent box attached with the display screen using short range wireless technology such as Bluetooth.

FIG. 10 illustrates a flow diagram depicting a method of targeting potential buyers according to a preferred embodiment of the present invention.

FIG. 11 illustrates a flow diagram depicting a method of retrieving and displaying data on the display media (screen) by use of stored content under remote control being used to deliver quality audio and/or video data/content.

FIG. 12 is an illustration of a scenario when the display media mechanism of the system is positioned in a moving vehicle. Due to various external factors like trees, the connecting means located inside the vehicle encounter problems connecting with the central data server as the communication network is erratic.

### DETAILED DESCRIPTION OF THE INVENTION:

Methods and systems of selection of content based on anticipation of the demographics and/or psychographics of the group from a remote central location through local commands on an input device for content that is sourced from the internet and/or the central database are provided. In the following description for purposes of explanation, specific details are set forth in order to provide a thorough understanding of the present invention. It will be evident, however, to one skilled in the art that the present invention may be practiced without these specific details and other configurations and arrangements can be used without departing from the spirit and scope of the invention. It will be apparent to a person skilled in the relevant art that this invention can also be employed in a variety of other devices and applications.

The present invention now will be described more fully hereinafter with reference to the accompanying drawings, which form a part hereof, and which show, by way of illustration, specific exemplary preferred embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

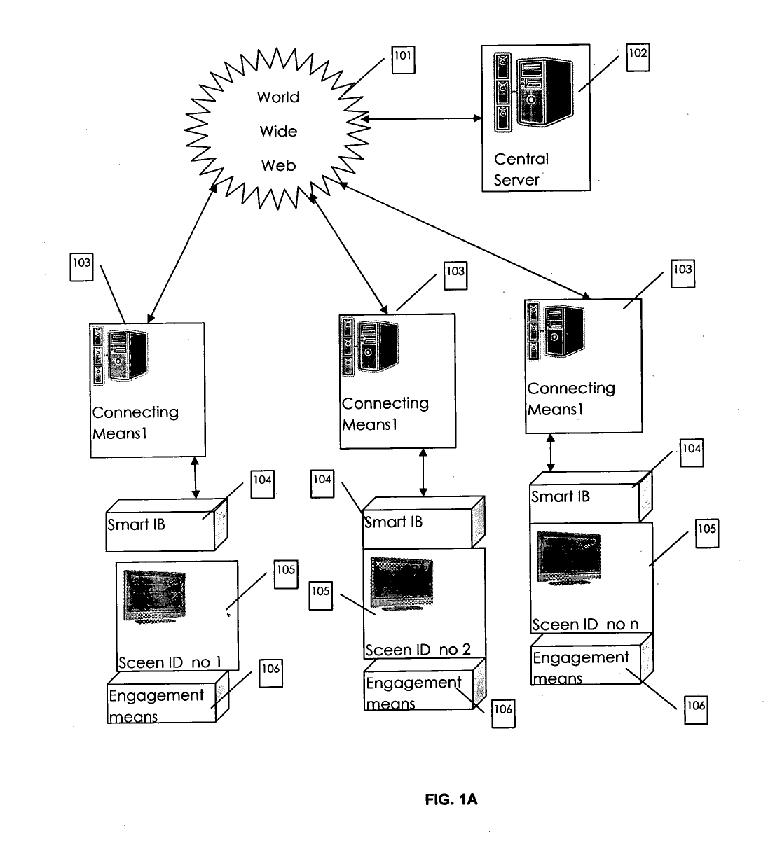

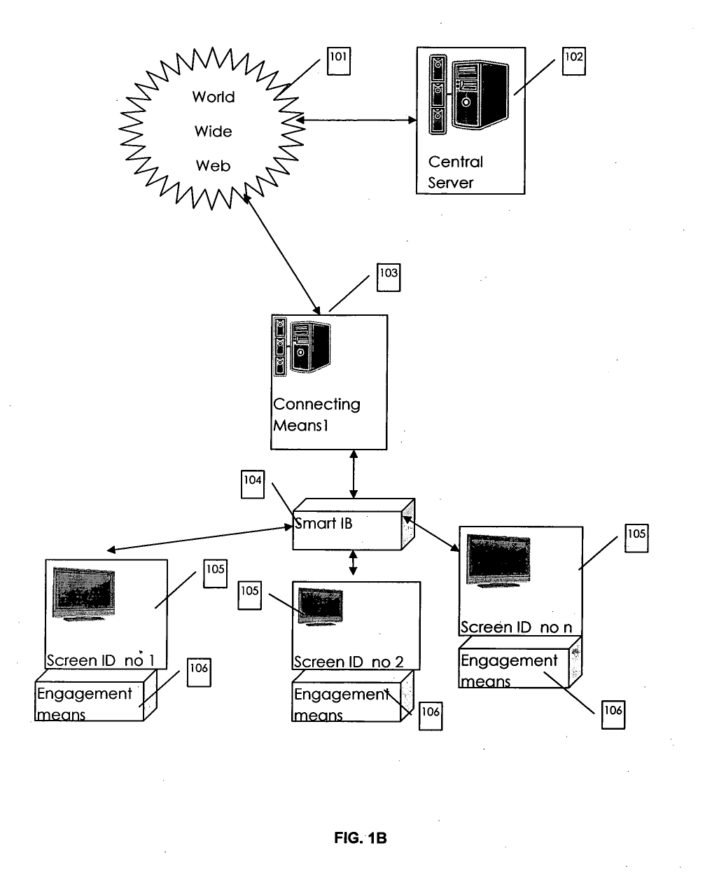

FIG. 1A illustrates a system for selection of content on anticipation of the demographic/psychographic of the group of remote central location through location commands on an input device wherein each display media has a respective connecting means, where the system comprises World Wide Web (Internet) 101, central server 102, plurality of connecting means 103, plurality of smart IBs 104, plurality of screen IDs 105 and plurality of engagement means 106. The system initializes display media (screens) with IDs 105, initializes database with demographic and psychographic content stored, in the central server 102, receives information fed through engagement means 106, update the database stored in the central server 102 accordingly, schedule the data/content on different regions according to the database containing psychographic, demographic data/content on different region.

The system facilitates the selection of content based on the anticipation of the demographic/psychographic of the group from a remote central location as against individual selection for content done by individuals through local commands on an input device for content that is sourced from the internet/or the central database. The display media (screens) with respective screen IDs are further attached to the engagement and connecting means. The engagement means could be a remote control device, and other mobile communication devices. The connecting means comprises of an Intelligent box [(Smart IBs including a CPU, wireless card, internet connecting cards, hard disk drive and intelligence means(the software)]. The system employing the environment provides the broadcaster, user and the location provider an optimum user friendly environment.

FIG. 1B illustrates a system for selection of content on anticipation of the demographic/psychographic of the group of remote central location through location commands on an input device wherein each display media is connected to a single connecting means where the system comprises World Wide Web (Internet) 101, central server 102, connecting means 103, smart IBs 104, screen IDs 105 and engagement means 106. The system initializes display media (screens) with IDs 105, initializes database with demographic and psychographic content stored in the central server 102, receives information fed through engagement means 106, update the database stored in the central server 102 accordingly, schedule the data/content on different regions according to the database containing psychographic, demographic data/content on different region.

Thus, the system uses just One smart IB (104), to connect with plurality of display screens (105) and plurality of engagement means (at least 1) (108). The smart IB (104) is thus responsible to maintain plurality of schedule list for different ID's. For examples screen ID 1 may have a different schedule list and screen ID2 may have a different schedule list. This schedule list and the corresponding data is fetched from a central repository of a central server(102) though connecting means (103) which enables a connection through a dedicated network of Internet (101). Though the central server here has been depicted as a single hardware unit, there can be plurality of such servers connected together and act as a repository. The Smart IB is connected with the screen and the engagement means. It may optionally maintain a log of the data sent and received from the engagement means and the central server. The Smart IB utilises the schedule list to pull data from the central server and push the data to the display media (screens).

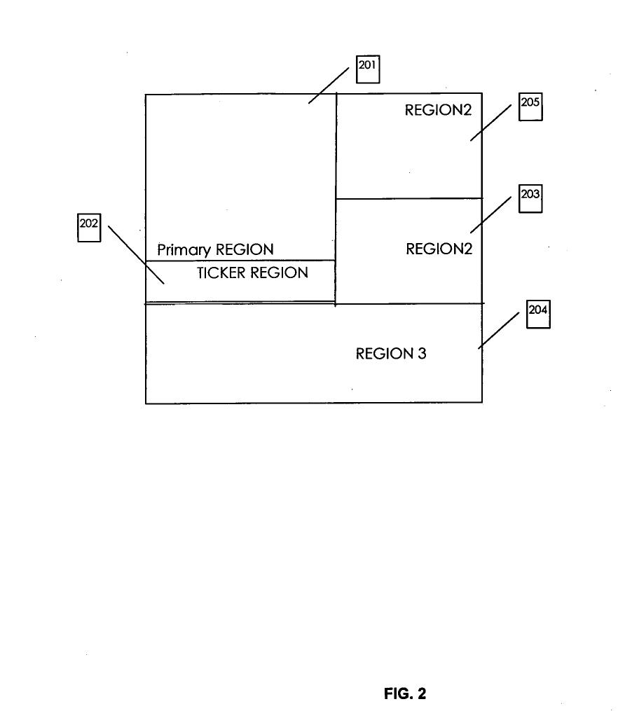

FIG. 2 depicts plurality of display regions wherein based on the display media (screen) ID data different regions display different data wherein display screen comprises at least one primary region 201, at least one ticker region 202, and al least region ‘A’ 203, region ‘B’ 204 and region ‘C’ 205.

The instant invention combines the power of ‘pull’ from the internet with the power to ‘push’ through a TV screen placed at a location group viewing using a remote control through a. set of commands transmitted over World Wide Web (internet)/secure network to the remotely located display. By dividing the viewable region into different regions, such regions are fed information through different sources like World Wide Web (internet), server, broadcast data and controlled through a centralized location. These regions are configurable based on demographic data/location data etc. Said demographic data can be partial demographic data for e.g. Mobile store could provide further filtering means of what to display and what not to display.

The number of display regions in FIG. 2 is for illustration only. Clearly, the invention is not limited to this illustrated example, a variety of other display modes having plurality of display regions may be aggregated, without departing from the scope or spirit of the invention.

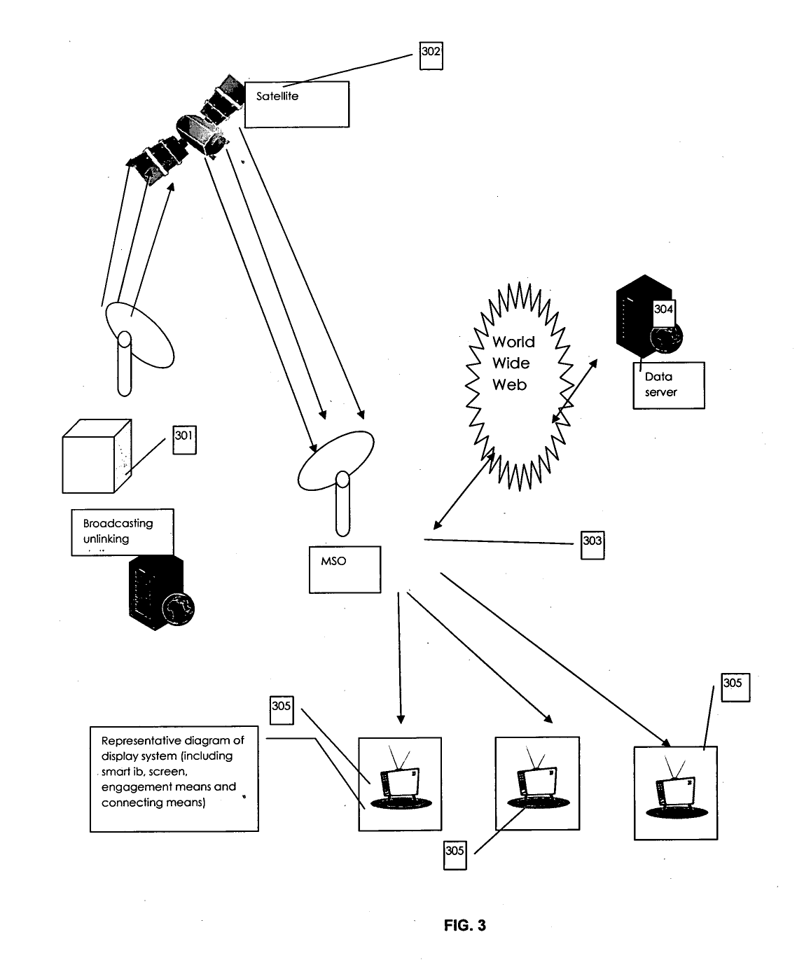

FIG. 3 illustrates a satellite and/or World Wide Web (Internet) transmission/reception system wherein the display media receives data from plurality of places viz. the internet (as push) and television broadcast (as pull). A broadcasting uplinking station 301 transmits multimedia-program information to a satellite 302. The satellite transmission/reception system may comprise a plurality of satellites receivers, wherein each satellite 302 may transmit a plurality of multimedia-program channels to a plurality of satellite receivers. The multimedia-program information for all channels that a cable TV service provider offers may be accumulated and encoded together at a satellite 302 receiver array location for further satellite transmission to a plurality of remotely located respective cable TV service provider (MSO) 303 for further dissemination and distribution to the display media (screens) 305.

An end-user can view a live feed of a channel on display media (screens) 305 with running advertisements while sitting in his room. A customized and localized element of live feed of the data/content can be created for delivery to the end-user from various sources. MSO 303 in a preferred embodiment of the present invention may receive the multimedia-program transmissions having the scheduled/customized data/content from the data server 304 on World Wide Web (Internet) and transmit such multimedia-program transmissions to the display media (screens) 305 from the various sources. For example, the end-user can view a list of available TV programs on a website associated with a cable TV station whereby scheduled/customized data/content (live feed of customized data/content) can be created for delivery to the display media (screens) 305 that incorporates portions of audio/video elements from one or more TV channels or other sources as per the effective relevancy of the advertisements on display.

In accordance with a preferred embodiment of the present invention, each of the plurality of multimedia-program transmissions may comprise a plurality of television channels, a plurality of internet transmissions, etc. The plurality of multimedia-program transmissions may be conveyed to content servers 303 residing at a plurality of cable TV service provider locations.

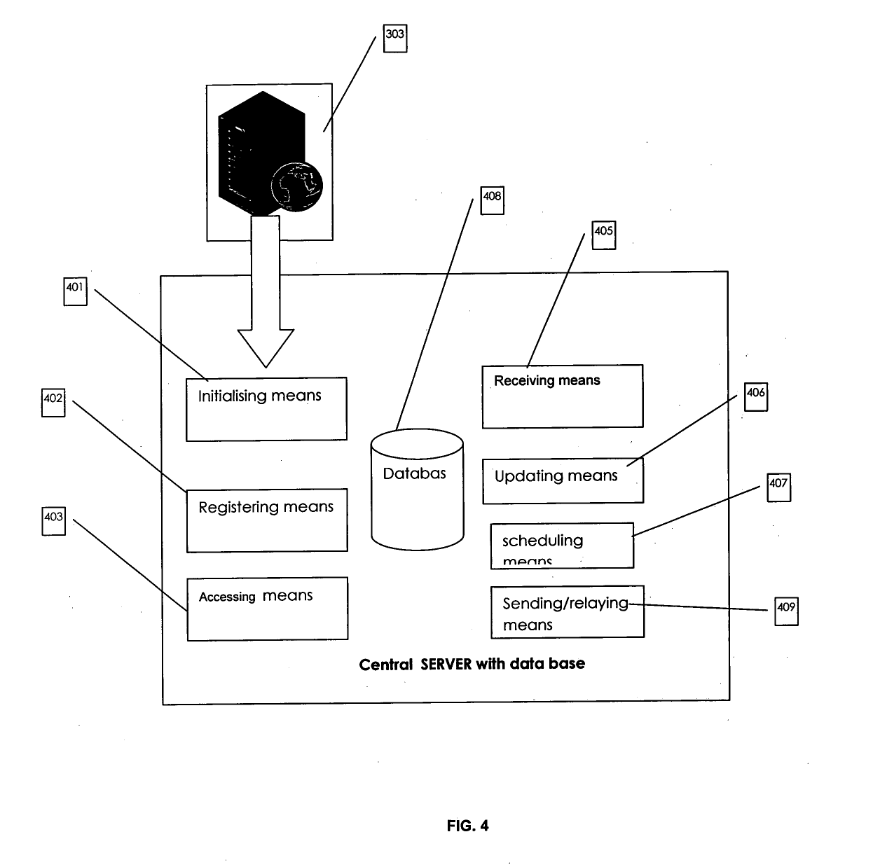

FIG. 4 is a block diagram illustrating an audio/video processing system which schedules the data/content on different display regions according to the database containing psychographic, demographic data/content on different display regions where the system comprises a central server 303 having initializing means 401, registering means 402, accessing means 403, receiving means 405, updating means 406, scheduling means 407, data base 408 and sending/relaying means 409. The system initializes display media (screens) with ids, initialize database with demographic and psychographic data/content, receive information fed through engagement means, update the database accordingly, schedule the data/content on different regions according to the database containing psychographic, demographic data/content on different display regions and send/relay through sending/relaying means.

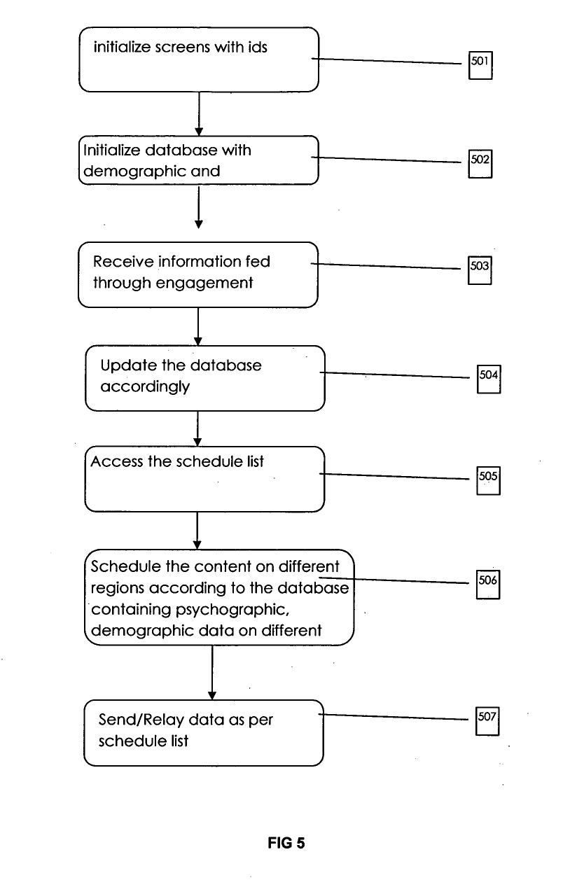

FIG. 5 is a flow diagram illustrating a method for selection of content on different display regions according to the database containing psychographic, demographic data on different regions where the method comprises the steps of initializing display media (screens) with ids 501, initializing database with demographic and psychographic data/content 502, receiving information fed through engagement means 503, updating the database accordingly 504, accessing the schedule list 505, scheduling the data/content on different regions according to the database containing psychographic, demographic data/content on different regions 506, sending/relaying data as per schedule list 507. The engagement means could be a remote control device, and other mobile communication devices. The connecting means comprises of an Intelligent box [(Smart IBs including a CPU, wireless card, Internet connecting cards, hard disk drive and intelligence means(the software)] The system thereof for selection of content on different display regions according to the database containing psychographic, demographic data on different regions, is comprised of means to initialize display media (screens) with ids, means to initialize database with demographic and psychographic data/content, means to receive information fed through engagement means, means to update the database accordingly, means to access the schedule list, means to schedule the data/content on different regions according to the database containing psychographic, demographic data/content on different regions, means to send/relay data/content as per schedule list.

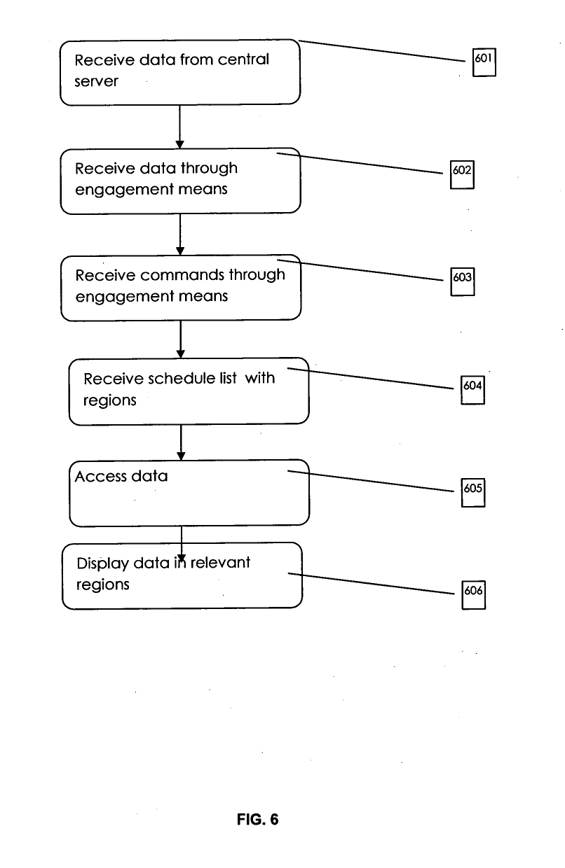

FIG. 6 is a flow diagram illustrating a method of dividing the viewable region of a display media (screen) with IDs into plurality of different regions, the method comprising the steps of receiving data/content from central server 601, receiving data/content through engagement means 602, receiving commands through engagement means 603, receiving schedule list with regions 604, accessing data/content 605, displaying data/content in relevant regions 606.

The system thereof to divide the viewable region of a display media (screen) with IDs into plurality of different display regions, is comprised of means to receive data/content from central server, engagement means to receive data/content, engagement means to receive commands, means to receive schedule list with regions, means to access data/content, means to display data/content in relevant regions.

Such regions are fed with information through different sources like internet, server, broadcast data/content and controlled through a centralized location. These regions are configurable based on demographic data/location data etc. Said demographic data can be partial demographic data for example Mobile store may provide further filtering means of what to display and what not to display.

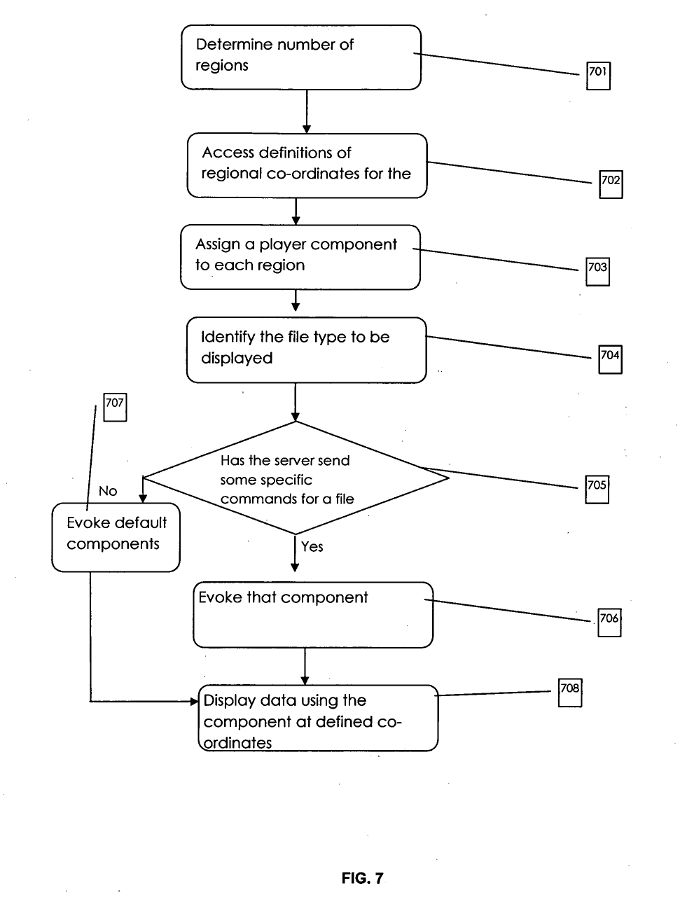

FIG. 7 is a flow diagram illustrating a method of determining number of regions of a display media (screen) with IDs with regional co-ordinates in plurality of display regions, the method comprising the steps of: determining number of display regions 701, accessing definitions of regional co-ordinates for the display media (screen) 702, assigning a player component to each such region 703, identifying the file-type to be displayed 704, evoking a player component if commands for a respective file-type received from the one or more server-end 706, evoking the default components if no commands received for a file-type from the one or more server-end 707, displaying data/content using the component at defined co-ordinates.

One or more central servers pass only the sequence of keyboard, mouse clicks and viewable area co-ordinates. Client pulls the content from internet and pushes it on the TV like display. Server pulls and extracts the viewable content from the internet and sends it as an HTML page to the client (end-user) which pushes it on the TV like display.

The system thereof to determine number of regions of a display media (screen) with IDs with regional co-ordinates in plurality of display regions, is comprised of means to determine number of display regions, means to access definitions of regional co-ordinates for the display media (screen), means to assign a player component to each such region, means to identify the file-type to be displayed, means to evoke a player component if commands for a respective file-type received from the one or more server-end, means to evoke the default components if no commands for a file-type received from the one or more server-end, means to display data/content using the component at defined co-ordinates.

A common platform of browser, which has all different types of plug-ins, can play content of multiple formats. This allows the system to embed multiple window frames running formats of plurality of content, for example, video, flash, ppt., jpeg, mpg4, avi., wmv. and so on through a common tool, e.g. a browser more particularly regional co-ordinates are given and these co-ordinates are assigned a player each, each player is capable of playing different formats of content. The player identifies the file type and calls in relevant components to enable the file-type to be displayed in the said display region, for example if the file is a image file like .jpeg an image viewer of the player is evoked, similarly if it is a video file a video rendering component of the player is evoked and so on the player identifies the file type and calls in relevant components. For certain contents the system we may send a command from the server that enforces the player to evoked a particular component for a particular file type thereby over-riding the defaults of the player.

The audio video (A/V) transmissions may be accumulated in a content server, for example—A data/content server is an information storage unit adapted to collect, accumulate, package, disseminate, and broadcast multimedia—(A/V) program data/information to clients at various locations remote from the central office. A common central content server may be located in a central office of a service provider.

Typically, audio video (A/V) transmissions are distributed to end-users over cables or wirelessly. The channels may be distributed from a content server located at a local cable TV service provider's location. The service provider's content server is adapted to transmit all of the channels simultaneously on a single shared cable to an end-user location.

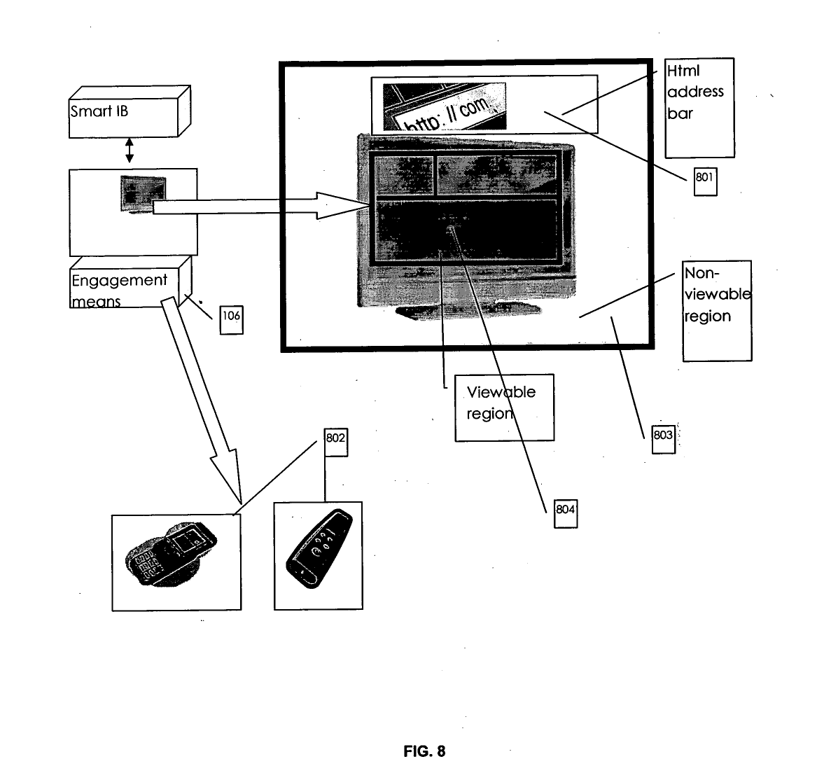

FIG. 8 illustrates a system of controlling the behaviour of the display device (screen) and its surroundings by one or more server through smart IBs or through engagement means 106. The display device (screen) contains viewable 804 and non viewable 803 area which can be controlled either by one or more server through smart IBs or through engagement means 106 like mobile communication device 802 or through a short range remote control device like IR remote 802. The said communication between mobile communication device and the system can be through SMS, GPRS or short range wireless communication like blue-tooth.

In a preferred embodiment, an html page could be created that would have viewable and non viewable areas. The said non-viewable areas lie beyond the co-ordinates of the display media (screen). Non-viewable area can contain control buttons that are used to control the behaviour of the display device (screen) and its surroundings for example, switch on, switch off, volume control, screen pull down, ambient light control through remote control such as IR, RS232 and so on.

The commands for the control of buttons are generated from instructions encoded in the input device rather through the keyboard or mouse. In disclosed system and method of the instant invention, a control for the browser window is sent for remotely controlling the content selection.

The viewable display area is defined as a region, screen, or application window that is used for displaying rich media content, and is distinct from content display area, previously being viewed by a user in a physical display area. Physical display area is the total area of an electronic device which is dedicated to and available for displaying information, such as a television's screen, a computer's monitor or a cellular phone's LCD display screen, whereas content display area is defined as the part of physical display area actually being used to display content at a given moment.

The system simulates signals corresponding to the device from where data needs to be pulled based on the requirements fed on the server (for scheduling etc.) Such signal may be a series of IR of short range radio signals. Thereby the whole behaviour of the display can be modified remotely. This system can also be utilised to control other features provided in the remote control of the device like modifying the brightness, sharpness volume etc. of an input signal through a central server.

The system integrates an intelligent hardware with an electronic display. The hardware contains the intelligence to receive commands/content through broadband, wireless, Bluetooth or a similar communication channel. The hardware further comprised the intelligence to analyse the location based context (demographics, time of the day, time of the year, surroundings like temperature etc., which can interface to multiple sensors like card readers etc). Based on the analysis of the context, the system and method thereof can pull content from Internet and/or central location and push the content on an electronic display viewed by a group of viewers at a certain location/or a group of locations.

Information of swiped card can be utilised to target the mobile communication device of such people to send a personalised message. Similarly a personalised message can be displayed on the common display media screen (system's display media screen).

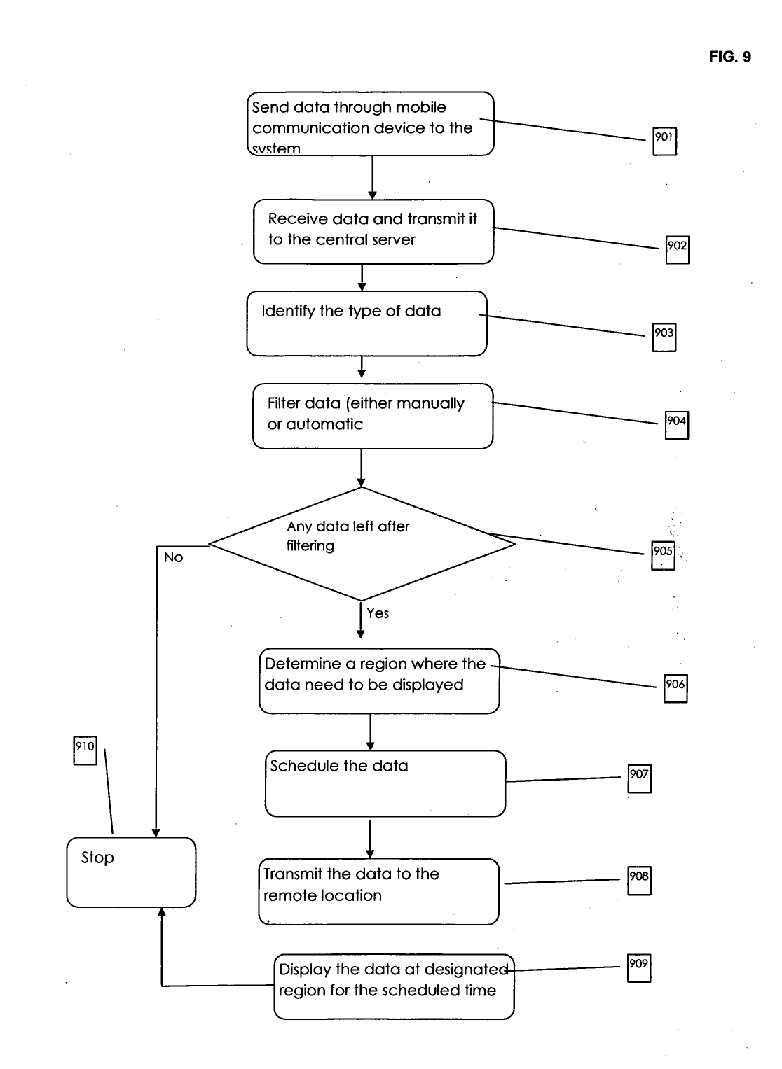

FIG. 9 is a flow diagram illustrating a method to utilize the options available in a mobile communication device to transmit data such as text, image or video data to the intelligent box attached with the display screen using short range wireless technology such as Bluetooth. The method comprises the steps of sending data/content through mobile communication device 901, receiving the data/content and transmitting the data/content to one or more central server 902, identifying the type of data/content 903, filtering the data/content 904, the data/content not being filtered out stopping the display of data/content at the designated display region 905, determining and designating a display region 906 and scheduling the data/content 907; transmitting the data/content to the remote location (smart IB) 908; and displaying the data/content at the designated display region the data/content being filtered out 909.

The data/content is fed to the server, synchronized, checked for bad illegal data (filtered) and the filtered data/content is scheduled in the server and then displayed.

The system thereof to transmit data/content to the intelligent box (IB) attached with the display media (screen) using short range wireless technology such as blue tooth in a mobile communication device, is comprised of means to send data/content through mobile communication device, means to receive the data/content, means to transmit the data/content to one or more central server, means to identify the type of data/content, means to filter the data/content, the data/content not being filtered out stopping the display of data/content at the designated display region, means to determine and designate a display region and scheduling the data/content, means to transmit the data/content to the remote location (smart IB); and means to display the data/content at the designated display region.

In a preferred aspect of the present method the system is location aware because of the prior knowledge of its location during installation/as well as based on the inputs or messages sensed by the appliance (e.g. messages from a cell phone or a touch screen). The system may further be sensor driven internet pull and display, for example, temperature sensor. Based on this, display media (screen) could run an advertisement for a sweater or a sun glass.

A mobile communication device may include at least one or other mobile devices also may include at least one other client application that is configured to receive content from another computing device. The client application may include a capability to provide and receive textual content, graphical content, audio content, and the like. The client application may further provide information that identifies itself, including a type, capability, name, and the like. In a preferred embodiment, mobile devices may uniquely identify themselves through any of a variety of mechanisms, including a phone number, Mobile Identification Number (MIN), an electronic serial number (ESN), or other mobile device identifier. The information may also indicate a content format that the mobile device is enabled to employ.

Mobile devices may be further configured to enable a user to participate in communications sessions, such as IM sessions. As such, mobile devices 102-104 may include a client application that is configured to manage various actions on behalf of the client device. For example, the client application may enable a user to interact with the browser application, email application, IM applications, SMS application, and the like.

The system pulls and displays information from the internet and/or from one or more central server based on plurality of parameters. For example, based on weather forecast for a location, an advertisement for products relevant to the forecasted weather may be displayed. In another example, an event happening can trigger a specific set of advertisements or inventory based advertising.

A touch screen application can run in one of the regions. While other regions may be utilised for display purposes. Similarly any other application may be assigned to be executed on a particular region of the display screen provided the application is configurable to execute on user configurable co-ordinates.

Using data base each system can be configured for a particular kind of RSS feed like weather temperature etc. Central server knows the demographic and geographic location, server therefore pulls relevant information from the internet (relevant to a particular screen) The Intelligence box (IBs) may also pull the data directly from internet (as per the commands received from the server).

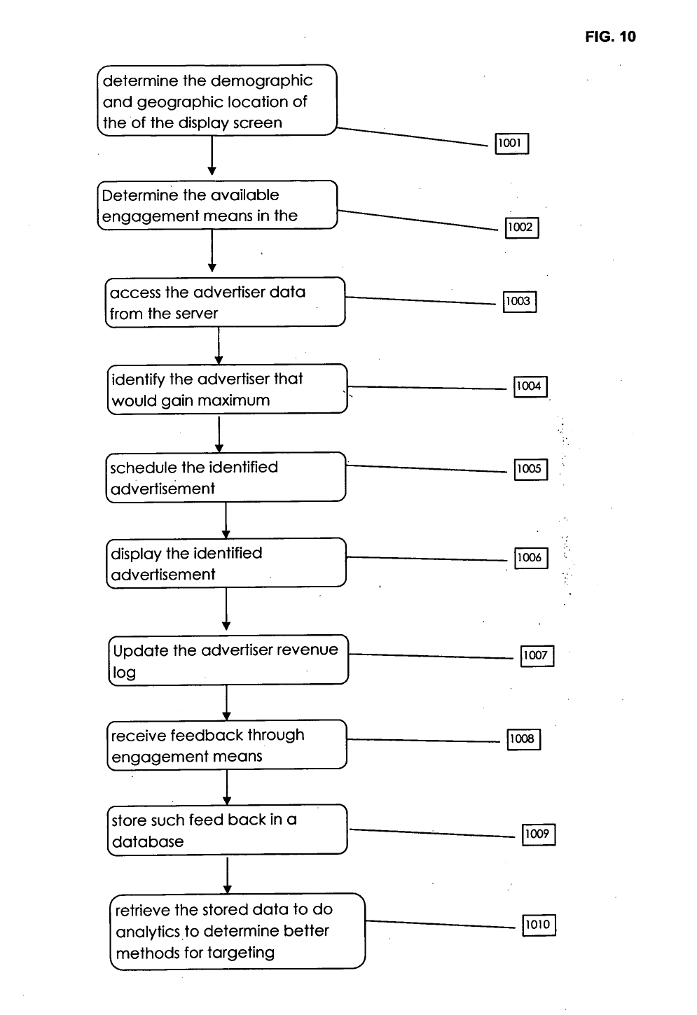

FIG. 10 is a flow diagram depicting a method of targeting potential buyers based on the selection of content on anticipation of the demographic/psychographic of the group of remote central location, the method comprises the steps of determining the demographic and geographic location of the of the display media (screen) 1001, determining the available engagement means in the display media (screen) 1002, accessing the advertiser data from the server 1003, identifying the advertiser that would gain maximum 1004, scheduling the identified advertisement 1005, displaying their advertisement 1006, updating the advertiser revenue log 1007, receiving feedback through engagement means 1008, storing such feed back in a database 1009, retrieving the stored data to do analytics to determine better methods for targeting 1010.

The system thereof to target potential buyers based on the selection of content on anticipation of the demographic/psychographic of the group of remote central location, is comprised of means to determine the psychographic, demographic and geographic location of the of the display media (screen), means to determine the available engagement means in the display media (screen), means to access the advertiser data from the server, means to identify the advertiser that would gain maximum, means to schedule the identified advertisement, means to display the identified advertisement, means to update the advertiser revenue log, means to receive feedback through engagement means, means to store such feed back in a database, means to retrieve the stored data to do analytics to determine better methods for targeting.

Thus, in a preferred embodiment the system and method utilises the demographic and geographic data available with it to create various subset like retail, corporate FMCG, sets based on people visiting the vicinity like their age group or buying capacity. The display media (screen) could be installed at variety of places such as in a shopping mall or a university etc.

The system in a preferred embodiment is configured basically for a combination of fixed parameters taken from the location based behaviour, with buying pattern, a sum of behaviour on mobile & web and the like. This information would be mainly used for targeting the user with specific Advertisement/content stored in a central web server. In a preferred embodiment, though the system is not limited to, the system may use web profile, mobile specific profile, location specific buying pattern, Location specific user profile and preferences, social profile and preference and the like information.

The data/content is created by pulling it from anywhere in the internet and pushed down to a group of displays based on a commonality of properties or locations. The system and method thereof can also act like a virtual kiosk based in interactive inputs received from the various locations. The system and method facilitate buying by an end-user using an out of home screen with engagement means and a mobile communication device. A set of commodities, like ring tones, wallpapers, etc are displayed on the OOH screen and on the mobile communication device of the user prompting the user's interest in such objects. The user may optionally be given an option to preview the object. The user could be prompted to buy an object/product where if the user selects to buy an object. The system and method thereof facilitate the user to buy the object either through prepaid account or buy it from the shopping establishment where display media (screen) is located, user in that case gets a validation key, which when entered by the user allows the user to download the object like whole song, high resolution pictures, movies, games etc, the validation key so entered is also saved with a time stamp in the centralised server.

Using the sale receipts (validation keys) the centralised server determines the share of the service provider, vendors (whose object was sold) and the shopping establishment. It further help determine who needs to pay how much to whom and accordingly generates periodic reports.

In alternate embodiments, the methods and systems of the instant invention may be used to facilitate News publish tools, content automation capability to gather location specific content and deliver on TV with editing capability, collaborative schedule control, content aggregation and delivery of TV like displays, customer specific logos, branded channels for customized communication strategy, and remote control of live TV/PVR capability for TV screens. The system and method of the instant invention may further facilitate intelligent content delivery by shared use of satellite bandwidth for delivery of customised video content saves on broadband bandwidth required for delivery of heavy duty video content for digital signage space and header protocol for delivery of client specific content on a group of screens.

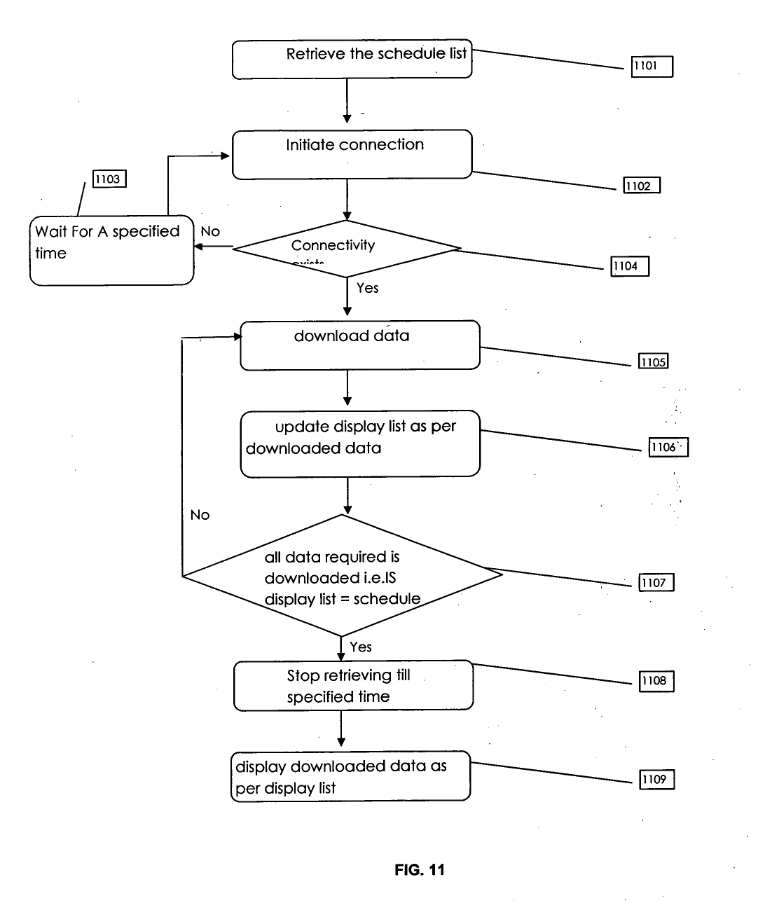

FIG. 11 is a flow diagram depicting a method of retrieving and displaying data on the display media (screen) by use of stored content under remote control being used to deliver quality audio and/or video data/content, the method comprises the steps of retrieving the schedule list 1101, initiating connection 1102, verifying if connectivity exists 1103, updating the schedule list if the connectivity exists 1104, downloading data/content 1105, updating downloaded data-list 1106, stopping retrieval of data/content till specified time till the time when all required data/content downloaded and display list equals the schedule list 1107, 1108, displaying downloaded data/content as per display list 1109, tracking/checking connectivity if no connectivity, displaying data/content as per display list.

The system thereof to retrieve and display data on the display media (screen) by use of stored content under remote control being used to deliver quality audio and/or video data/content, is comprised of means to retrieve the schedule list, means to initiate connection; means to verify if connectivity exists, means to update the schedule list if the connectivity exists, means to download data/content, means to update downloaded data-list, means to stop retrieval of data/content till specified time till the time when all required data/content downloaded and display list equals the schedule list, means to display downloaded data/content as per display list and means to track/check connectivity.

The method and system thereof uses stored content under remote control which can be used to deliver quality video and avoid the effects of trees, bridges, tall buildings etc. for trains and buses general instances of irratic communication network problems. Generally while on move the display media (screen) may not get the connectivity everywhere therefore the systems smart IB which already contains a hard disk drive come into picture buffering extra bytes.

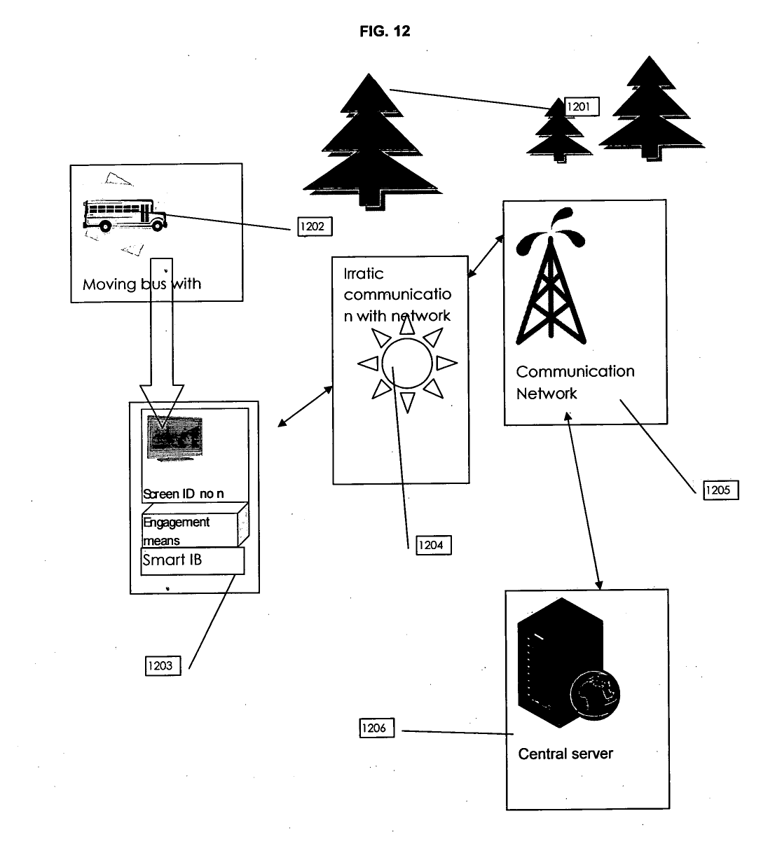

FIG. 12 is an illustration of a scenario when the display mechanism (1203) of the system is positioned in a moving vehicle (1202). Due to various external factors like trees (1201), the connecting means located inside the vehicle encounter problems connecting with the central data server (1206) as the communication network (1204) is erratic. To circumvent this problem the system uses a method as illustrated in FIG. 11. Thus the system is able to provide the end user an uninterrupted viewing experience.

The blocks of the flowchart illustration support combinations of means for performing the specified actions, combinations of steps for performing the specified actions and program instruction means for performing the specified actions.

Although, the invention has been described with reference to specific examples, it would be appreciated by those skilled in the art that the invention may be embodied in many forms without departing from the broader spirit and scope of the invention as set forth in the invention. Preferred embodiments of this invention have been described herein, including the best mode known to the inventor for carrying out the invention. Variations of those preferred embodiments may become apparent to those of ordinary skill in the art upon reading the foregoing description.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. Accordingly, the specification and drawings are to be regarded in an illustrative rather than a restrictive sense without departing from the spirit and scope of the invention, the invention resides in the claims hereinafter appended.

I/we claim:

1. A system for selection of content on anticipation of the demographic/psychographic of the group of remote central location through location commands on an input device, where the system comprises:
World Wide Web (Internet) connected to a central server through connecting means,
smart IBs to pull data/content from World Wide Web (Internet);
display media (screen) IDs attached to the engagement and connecting means.

2. The system as claimed in claim 1, wherein the engagement means comprises a remote control device, and other mobile communication devices.

3. The system as claimed in claim 1, wherein the connecting means comprises an Intelligent box (Smart IBs) including a CPU, wireless card, internet connecting cards, hard disk drive and intelligence means(the software).

4. The system as claimed in claim 1, wherein the display media (screen) viewable region divided into different regions.

5. The system as claimed in claim 4, wherein the display media (screen) comprises at least one primary region, at least one ticker region, and al least region ‘A’, region ‘B’ and region ‘C’.

6. The system as claimed in claim 1 wherein the system utilizes one smart IB to connect with plurality of display screens and plurality of engagement means.

7. An audio/video processing system which schedules the data/content on different display regions according to the database containing psychographic, demographic data/content, the system comprising:
a central server having initializing means to initialize display media with ids and to initialize database with demographic and psychographic content;
registering means to register the data/content;
accessing means to access the data/content;
receiving means to receive data fed through engagement means;
updating means to update the database;
scheduling means to schedule the data/content on different regions according to the database containing psychographic, demographic data on different display regions; and
sending/relaying means to send/relay data/content on different display regions.

8. A method for selection of content on different display regions according to the database containing psychographic, demographic data on different regions, the method comprising the steps of:
initializing display media (screens) with ids;
initializing database with demographic and psychographic data/content;
receiving information fed through engagement means;
updating the database accordingly;
accessing the schedule list;
scheduling the data/content on different regions according to the database containing psychographic, demographic data/content on different regions;
sending/relaying data/content as per schedule list.

9. A system for selection of content on different display regions according to the database containing psychographic, demographic data on different regions, the system comprising:
means to initialize display media (screens) with ids;
means to initialize database with demographic and psychographic data/content;
means to receive information fed through engagement means;
means to update the database accordingly;
means to access the schedule list;
means to schedule the data/content on different regions according to the database containing psychographic, demographic data/content on different regions;
means to send/relay data/content as per schedule list.

10. A method of dividing the viewable region of a display media (screen) with IDs into plurality of different display regions, the method comprising the steps of:
receiving data/content from central server;
receiving data/content through engagement means;
receiving commands through engagement means;
receiving schedule list with regions;
accessing data/content;
displaying data/content in relevant regions.

11. The method as claimed in claim 10, wherein viewable regions are fed with information through different sources viz. internet, server, broadcast data/content and controlled through a centralized location.

12. A system to divide the viewable region of a display media (screen) with IDs into plurality of different display regions, the system comprising:
means to receive data/content from central server;
engagement means to receive data/content;
engagement means to receive commands;
means to receive schedule list with regions;
means to access data/content;
means to display data/content in relevant regions.

13. A method of determining number of regions of a display media (screen) with IDs with regional co-ordinates in plurality of display regions, the method comprising the steps of:
determining number of display regions;
accessing definitions of regional co-ordinates for the display media (screen);
assigning a player component to each such region;
identifying the file-type to be displayed;
evoking a player component if commands for a respective file-type received from the one or more server-end;
evoking the default components if no commands for a file-type received from the one or more server-end;
displaying data/content using the component at defined co-ordinates.

14. A system to determine number of regions of a display media (screen) with IDs with regional co-ordinates in plurality of display regions, the system comprising:
means to determine number of display regions;
means to access definitions of regional co-ordinates for the display media (screen);
means to assign a player component to each such region;
means to identify the file-type to be displayed;
means to evoke a player component if commands for a respective file-type received from the one or more server-end;
means to evoke the default components if no commands for a file-type received from the one or more server-end; means to display data/content using the component at defined co-ordinates.

15. A method to transmit data/content to the intelligent box (IB) attached with the display media (screen) using short range wireless technology such as blue tooth in a mobile communication device, the method comprising the steps of:
sending data/content through mobile communication device;
receiving the data/content;
transmitting the data/content to one or more central server;
identifying the type of data/content;
filtering the data/content, the data/content not being filtered out stopping the display of data/content at the designated display region
determining and designating a display region and scheduling the data/content;
transmitting the data/content to the remote location (smart IB); and
displaying the data/content at the designated display region the data/content being filtered out.

16. The method as claimed in claim 15, wherein the display media (screen) contains viewable and non viewable area controlled either by one or more server through smart IBs or through engagement means like mobile communication device or through a short range remote control device like IR remote.

17. The method as claimed in claim 15, wherein the non-viewable area comprises control buttons that are used to control the behaviour of the display media (screen) and its surroundings.

18. A system to transmit data/content to the intelligent box (IB) attached with the display media (screen) using short range wireless technology such as blue tooth in a mobile communication device, the system comprising:
means to send data/content through mobile communication device;
means to receive the data/content;
means to transmit the data/content to one or more central server;
means to identify the type of data/content;
means to filter the data/content, the data/content not being filtered out stopping the display of data/content at the designated display region
means to determine and designate a display region and scheduling the data/content;
means to transmit the data/content to the remote location (smart IB); and
means to display the data/content at the designated display region.

19. A method of targeting potential buyers based on the selection of content on anticipation of the demographic/psychographic of the group of remote central location, the method comprising steps of :
determining the demographic and geographic location of the of the display media (screen);
determining the available engagement means in the display media (screen);
accessing the advertiser data from the server;
identifying the advertiser that would gain maximum;
scheduling the identified advertisement;
displaying identified advertisement;
updating the advertiser revenue log;
receiving feedback through engagement means;
storing such feed back in a database;
retrieving the stored data to do analytics to determine better methods for targeting.

20. A system to target potential buyers based on the selection of content on anticipation of the demographic/psychographic of the group of remote central location, the system comprising :
means to determine the psychographic, demographic and geographic location of the of the display media (screen);
means to determine the available engagement means in the display media (screen);
means to access the advertiser data from the server;
means to identify the advertiser that would gain maximum;
means to schedule the identified advertisement;
means to display the identified advertisement;
means to update the advertiser revenue log;
means to receive feedback through engagement means;
means to store such feed back in a database;
means to retrieve the stored data to do analytics to determine better methods for targeting.

21. A method of retrieving and displaying data on the display media (screen) by use of stored content under remote control being used to deliver quality audio and/or video data/content, the method comprising the steps of:
retrieving the schedule list
initiating connection;
verifying if connectivity exists,
updating the schedule list if the connectivity exists;
downloading data/content;
updating downloaded data-list,
stopping retrieval of data/content till specified time till the time when all required data/content downloaded and display list equals the schedule list;
displaying downloaded data/content as per display list; tracking/checking connectivity if no connectivity, displaying data/content as per display list.

22. A system to retrieve and display data on the display media (screen) by use of stored content under remote control being used to deliver quality audio and/or video data/content, the system comprising:
means to retrieve the schedule list
means to initiate connection;
means to verify if connectivity exists,
means to update the schedule list if the connectivity exists;
means to download data/content;
means to update downloaded data-list,
means to stop retrieval of data/content till specified time till the time when all required data/content downloaded and display list equals the schedule list;
means to display downloaded data/content as per display list;
means to track/check connectivity.
